(19) United States
(12) Patent Application Publication
(10) Pub. No.: US 2015/0293834 A1
(43) Pub. Date: Oct. 15, 2015

(54) Methods, Apparatus, and Computer Readable Media for Providing a Governance Framework for Declarative Rule Based Programming

(71) Applicant: SYNECHRON HOLDINGS, INC., ROAD TOWN (VG)

(72) Inventor: Kedar N. Potdar, Bloomingdale, IL (US)

(73) Assignee: SYNECHRON HOLDINGS, INC., ROAD TOWN (VG)

(21) Appl. No.: 14/250,887

(22) Filed: Apr. 11, 2014

(51) Int. Cl. G06F 11/36; G06F 9/44

(52) U.S. Cl. CPC G06F 11/3688; G06F 8/70

(57) ABSTRACT

A governance framework may be used to for developing software that may use a business process management platform (BPM), such as BPM software by Pega Systems. The governance framework may help to prevent software bugs. For example, the governance framework may prevent developers from checking in code that may have violations, bugs, and/or errors. The governance framework may ensure that code adhere to guardrails, for example, by monitoring developer activity and identifying potential issues. The governance framework may reduce defect rates for a software program that may be developed. For example, the governance framework may improve the quality of a software product while decreasing development time by catching potential defects. The governance framework may ensure that a development team creates software efficiently, for example, by providing a velocity report for the development team. The velocity report may show the performance of the development team.

### BACKGROUND

There has been a demand for software solutions that utilize a business process management (BPM) platforms, such as Pegasystem, which may use a declarative rule-based programming language. A BPM platform may provide a systematic approach that may allow an organization to improve its processes, which may impact the cost and revenue generation of the organization.

Although there is a demand for development on such a platform, many developers may not be familiar with the declarative rule-based programming language that may be used by the BPM platform. Rather, these developers are more familiar with a procedure-based programming language, such as C or Java. Accordingly, these developers may choose to develop software for the BPM platform using a procedure-based programming language, which may then be translated into a declarative rule-based programming language. But, a software developer using a procedure-based programming language to develop software for the BPM platform may introduce software errors due to their lack of familiarity with the BPM platform.

### SUMMARY

Disclosed herein are methods and apparatus for providing a governance framework (SGF). A governance framework may be used to for developing software that may use a business process management platform (BPM), such as BPM software by Pega Systems. The governance framework may help to prevent software bugs. For example, the governance framework may prevent developers from checking in code that may have violations, bugs, and/or errors. The governance framework may ensure that code adhere to guardrails, for example, by monitoring developer activity and identifying potential issues. The governance framework may reduce defect rates for a software program that may be developed. For example, the governance framework may improve the quality of a software product while decreasing development time by catching potential defects. The governance framework may ensure that a development team creates software efficiently, for example, by providing a velocity report for the development team. The velocity report may show the performance of the development team.

The governance framework may ensure that a software product may be able to scale in the future. For example, the governance framework may monitor code that may result in orphaned objects and/or wasted memory. The governance framework may analyze a software program to determine how the program may perform with an increased load. For example, the governance framework may monitor usage and may provide health reports for the software. The governance framework may analyze a software product to determine how that product may react with multiple applications.

A computing device may provide governance framework. The computing device may include a processor that may be configured to perform a number of actions. For example, the processor may be configured to determine a rule to be integrated into an application that may be developed on a business process management (BPM) platform. A ruleset may be determined may be based on the rule. The ruleset may be for preventing defects from being introduced into the application. An error may be detected within the rule by applying the ruleset to the rule. A developer may be notified of the error within the rule. A team lead may be determined to approve the rule before it may be integrated into the application. A work item may be generated when the rule includes an error. The work item may be assigned to the developer to ensure that the developer corrects the error. The team lead may be notified that the work item may have been assigned.

A work item may be assigned to the team lead to ensure that the team lead approves the rule. An approval may be received from the team lead and integrate the rule into the application.

The rule may be written in a programming language that may be not native to the BPM platform. The rule may be written in a procedural-rule may be based programming language and the BPM platform uses a declarative-rule may be based programming language. The rule may comprise an objective and a circumstance.

A computing device may provide governance framework. The computing device may include a processor that may be configured to perform a number of actions. For example, a data instance may be received that may be integrated into an application being developed on a business process management (BPM) platform. A validation for the application to be used for the data instance may be determined. It may be determined that the data instance fails the validation beyond a threshold. A save level may be determined. The save level indicating a number of times a developer may have attempted to save the data instance.

The save level may be a first save, and a warning may be displayed to a developer associated with the data instance. And, a work object may be assigned to the developer.

The save level may be a second save, the work object may be a first work object, and the processor may be further configured to assign a second work object to a tech lead. An approval may be received from the tech lead. A rejection may be received from the tech lead and the developer may be notified of the rejection from the tech lead.

A computing device may provide governance framework. The computing device may include a processor that may be configured to perform a number of actions. For example, an instance, such as a special instance, to be integrated into an application being developed on a business process management (BPM) platform may be received. A validation to be used for the instance may be determined. It may be determined that the instance does not pass the validation. A work object may be generated that may include information about the instance. The work object may be assigned to a user to request that the user review the instance before the instance may be introduced into the application.

An approval from the user may be received from a user. The work object may be resolved. A transaction table may be updated. A warning message may be removed from a rule.

The user may be a first user and the processor may be further configured to receive a message from the first user indicating that the instance may be modified. The work object may be assigned to the second user.

The Summary is provided to introduce a selection of concepts in a simplified form that are further described in the Detailed Description. This Summary is not intended to identify key or essential features of the claimed subject matter, nor is it intended to be used to limit the scope of the claimed subject matter. Furthermore, the claimed subject matter is not limited to any limitations that solve any or all disadvantages noted in any part of this disclosure.

### BRIEF DESCRIPTION OF THE DRAWINGS

Methods and apparatus for cycle accurate time stamping at line rate throughput are further described with the reference to the following drawings:

FIG. 1 illustrates an example of a computing environment that may be used to implement a governance framework.

FIG. 2 depicts an example software architecture that may use a governance framework.

FIG. 3 illustrates a diagram for a governance framework.

FIGS. 4A and 4B depict a class structures that may be used to implement a governance framework.

FIG. 5 depicts a class structure that may be to implement reporting for a governance framework.

FIG. 6 depicts a class structure that may be used to implement configuration settings for a governance framework.

FIG. 7 depicts a diagram that may be used to provide a rule instance validation for a governance framework.

FIG. 8 depicts a diagram that may be used by a governance framework to check in a rule.

FIG. 9 depicts a diagram that may be used to by a governance framework to provide a rule approval process.

FIG. 10 depicts a diagram that may be used by a governance framework to provide data instance validation.

FIG. 11 depicts a diagram that may be used by a governance framework to provide data instance validation.

FIG. 12 depicts a diagram that may be used by a governance framework to provide special instance validation.

FIG. 13 depicts a method for calculating developer and/or team velocity.

FIG. 14 depicts data classes that may be used for velocity calculation.

FIG. 15 depicts an example of an application with a governance framework (SGF) enabled.

FIG. 16 depicts an example of a multiple applications with a governance framework (SGF) enabled.

FIG. 17 depicts an example of multiple applications where an application may have a governance framework (SGF) enabled.

### DETAILED DESCRIPTION OF ILLUSTRATIVE EMBODIMENTS

A detailed description of illustrative embodiments will be described with reference to the Figures. Although this description provides a detailed example of possible implementations, the details are intended to be exemplary and do not limit the scope of the application.

There has been a demand for software solutions that utilize a business process management (BPM) platforms, such as Pegasystem, which may use a declarative rule-based programming language. A BPM platform may provide a systematic approach that may allow an organization to improve its processes, which may impact the cost and revenue generation of the organization.

Although there is a demand for development on such a platform, many developers may not be familiar with the declarative rule-based programming language that may be used by the BPM platform. Rather, these developers are more familiar with a procedure-based programming language, such as C or Java. Accordingly, these developers may choose to develop software for the BPM platform using a procedure-based programming language, which may then be translated into a declarative rule-based programming language. But, a software developer using a procedure-based programming language to develop software for the BPM platform may introduce software errors due to their lack of familiarity with the BPM platform.

A procedural-based programming language, such as C or Java, may be a language where execution may be controlled by procedures. The procedures may consist of statements, such as assignments, loops, if statements, or the like. When using a procedural-based programming language, a developer may specify the sequence of instructions that may be executed.

A declarative rule-based programming language may not have sequential statements. Processing may be specified in the form of logical rules that may relate to variables. These rules may be linked together so that the output of one rule may become an input to another rule. These rules may allow a developer to focus on a desired behavior of an application rather than to specify the sequence of instructions that may be executed.

A BPM platform may use a declarative rule-based programming language. But, developers may not be familiar with the declarative rule-based programming language. To make up for the lack of knowledge, many BPM platforms offer translators that may translate a procedural-based programming language to the declarative rule-based programming language. Programmers may and then use the procedural-based programming language to design software solutions that may utilize the BPM platform. However, when the programmers use the procedural-based programming language, they may introduce defects into the software solution. This may occur due to the lack of the developer's understanding of the structure or requirements of the BPM software.

A governance framework may be used to prevent software developers from introducing defects into a software solution while developing the software solution using a procedural-based programming language or a declarative rule-based programming language. This may be done, for example, by monitoring the code, enforcing rules and/or guidelines, or the like. The rules and/or guidelines may be determined by analyzing code that may be written in a procedural-based programming language and determining how that code would be converted into a declarative rule-based programming language. The rules and/or guidelines may be part of the governance framework system. For example, the rules and/or guidelines may be best practices for an industry and may be included as part of the governance framework. The rules and/or guidelines may be created by a developer using the governance framework. For example, a developer may create a number of rules and may check those rules into the governance framework. The governance framework may then analyze a software project using those rules and may enforce those rules against the software project. The rules and/guidelines may be determined by analyzing best practices for software development languages, analyzing the function of the software solution, analyzing software that may be used along with the software solution, analyzing databases that may be utilized, a combination thereof, or the like.

The governance framework may receive a number of rules and/or guidelines from a development lead that may be responsible for managing a team of developers. The development lead may use the governance framework to improve the quality of the software solution, reduce the number of defects that may be introduced to the software solution, monitor the performance of software developers, a combination thereof, or the like. For example, the development lead may set the governance framework to monitor code written by a software development team. The code may be written in a programming language that may or may not be native to the BPM platform. For example, a declarative-rule based programming language may be native to the BPM platform, but the software developer may use a procedural-rule based programming language. The governance framework may detect defects in the code written by the software development team and may notify the developer that wrote the code and/or may notify the development lead.

The governance framework may be used to for developing software that may use a business process management platform (BPM), such as BPM software by Pega Systems. The governance framework may help to prevent software bugs. For example, the governance framework may prevent developers from checking in code that may have violations, bugs, and/or errors. The governance framework may ensure that code adhere to guardrails, for example, by monitoring developer activity and identifying potential issues. The governance framework may reduce defect rates for a software program that may be developed. For example, the governance framework may improve the quality of a software product while decreasing development time by catching potential defects. The governance framework may ensure that a development team creates software efficiently, for example, by providing a velocity report for the development team. The velocity report may show the performance of the development team.

The governance framework may ensure that a software product may be able to scale in the future. For example, the governance framework may monitor code that may result in orphaned objects and/or wasted memory. The governance framework may analyze a software program to determine how the program may perform with an increased load. For example, the governance framework may monitor usage and may provide health reports for the software. The governance framework may analyze a software product to determine how that product may react with multiple applications.

The governance framework may assist in creating and maintaining a software development environment that produces less errors or bugs. For example, the governance framework may be concerned with ensuring that policies and procedures are established and enforced. The governance framework may be deployed for a BPM application and may provide a source of guidelines for the BPM application. The governance framework may provide metrics that may be used to measure how successfully the development of a BPM program may be. The governance framework may be included within a development environment such that the framework may be able to enforce guidelines and measure metrics without impeding development.

By providing guidelines and/or enforcing best practices, the governance framework may be able to improve the efficiency of software developers that may be developing a program. The framework may enable developer to reduce the time to develop software, reduce development costs, reduce a rate of detects and/or downtime, improve performance on production systems, a combination thereof, or the like. The framework may also allow for increased control and/or visibility in the development cycle, may accelerate product enhancements, and may improve product quality, a combination thereof, or the like.

A governance framework may be used with a BPM platform so that developers are able to efficiently create custom BPM software. For example, the governance framework may use a PegaRule process commander design so that the governance framework may be used with Pegasystem software. When used with Pegasystem software, the governance framework may improve the quality, compliance, and deliver of code in a PRPC development environment. This may be done, for example, by enforcing practices and guardrails to be followed during the development cycle. The governance framework may audit software to find and/or prevent defects. The governance framework may provide an approval cycle for failed audits to coordinate the efforts of large development teams or to control changes to applications. The governance framework may provide developers with warnings, rule views, metrics, a combination thereof, or the like.

A computing device may provide governance framework. The computing device may include a processor that may be configured to perform a number of actions. For example, the processor may be configured to determine a rule to be integrated into an application that may be developed on a business process management (BPM) platform. A ruleset may be determined may be based on the rule. The ruleset may be for preventing defects from being introduced into the application. An error may be detected within the rule by applying the ruleset to the rule. A developer may be notified of the error within the rule. A team lead may be determined to approve the rule before it may be integrated into the application. A work item may be generated when the rule includes an error. The work item may be assigned to the developer to ensure that the developer corrects the error. The team lead may be notified that the work item may have been assigned.

A work item may be assigned to the team lead to ensure that the team lead approves the rule. An approval may be received from the team lead and integrate the rule into the application.

The rule may be written in a programming language that may be not native to the BPM platform. The rule may be written in a procedural-rule may be based programming language and the BPM platform uses a declarative-rule may be based programming language. The rule may comprise an objective and a circumstance.

A computing device may provide governance framework. The computing device may include a processor that may be configured to perform a number of actions. For example, a data instance may be received that may be integrated into an application being developed on a business process management (BPM) platform. A validation for the application to be used for the data instance may be determined. It may be determined that the data instance fails the validation beyond a threshold. A save level may be determined. The save level indicating a number of times a developer may have attempted to save the data instance.

The save level may be a first save, and a warning may be displayed to a developer associated with the data instance. And, a work object may be assigned to the developer.

The save level may be a second save, the work object may be a first work object, and the processor may be further configured to assign a second work object to a tech lead. An approval may be received from the tech lead. A rejection may be received from the tech lead and the developer may be notified of the rejection from the tech lead.

A computing device may provide governance framework. The computing device may include a processor that may be configured to perform a number of actions. For example, an instance, such as a special instance, to be integrated into an application being developed on a business process management (BPM) platform may be received. A validation to be used for the instance may be determined. It may be determined that the instance does not pass the validation. A work object may be generated that may include information about the instance. The work object may be assigned to a user to request that the user review the instance before the instance may be introduced into the application.

An approval from the user may be received from a user. The work object may be resolved. A transaction table may be updated. A warning message may be removed from a rule.

The user may be a first user and the processor may be further configured to receive a message from the first user indicating that the instance may be modified. The work object may be assigned to the second user.

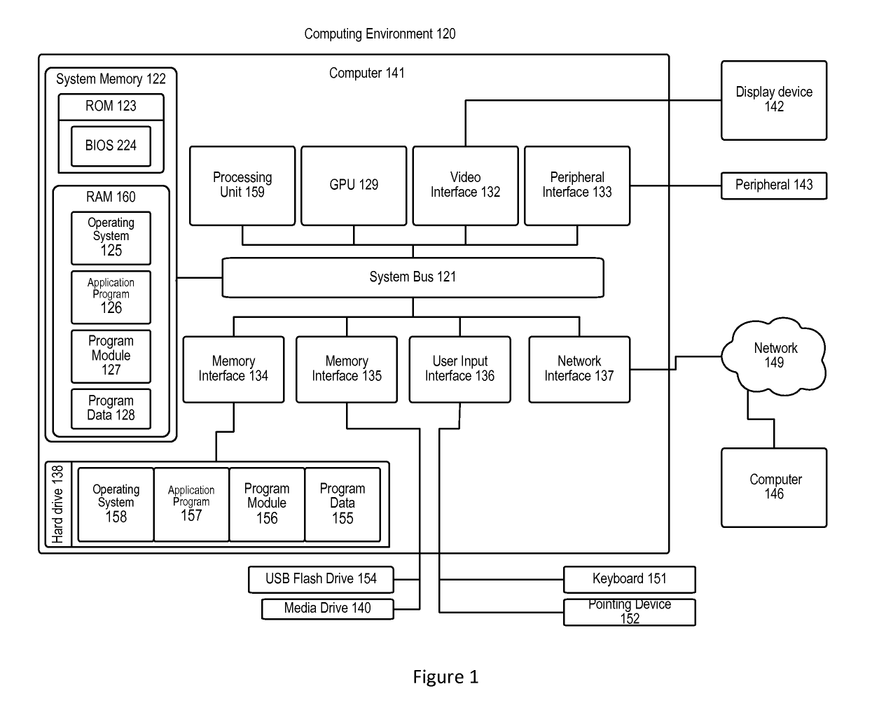

FIG. 1 illustrates an example of a computing environment that may be used to implement a governance framework. Computing system environment 120 is not intended to suggest any limitation as to the scope of use or functionality of the disclosed subject matter. Computing environment 120 should not be interpreted as having any dependency or requirement relating to the components illustrated in FIG. 1. For example, in some cases, a software process may be transformed into an equivalent hardware structure, and a hardware structure may be transformed into an equivalent software process. The selection of a hardware implementation versus a software implementation may be one of design choice and may be left to the implementer.

The computing elements shown in FIG. 1 may include circuitry that may be configured to implement aspects of the disclosure. Circuitry may include hardware components that may be configured to perform function(s) by firmware or switches. Circuitry may include a processor, a memory, or the like that may be configured by software instructions. Circuitry may include a combination of hardware and software. For example, source code that may embody logic may be compiled into machine-readable code and may be processed by a processor.

As shown in FIG. 1, computing environment 120 may include computer 141 and may include a variety of computer readable media that may be accessed by computer 141. The computer readable media may include volatile media, nonvolatile media, removable media, non-removable media, or the like. System memory 122 may include read only memory (ROM) 123 and random access memory (RAM) 160. ROM 123 may include basic input/output system (BIOS) 124. BIOS 124 may include basic routines that may help to transfer data between elements within computer 141 during start-up. RAM 160 may include data and/or program modules that may be accessible to by processing unit 159. ROM 123 may include operating system 125, application program 126, program module 127, and program data 128.

Computer 141 may also include other computer storage media. For example, computer 141 may include hard drive 138, media drive 140, USB flash drive 154, or the like. Media drive 140 may be a DVD/CD drive, hard drive, a disk drive, a removable media drive, flash memory cards, digital versatile disks, digital video tape, solid state RAM, solid state ROM, or the like. The media drive 140 may be internal or external to computer 141. Computer 141 may access data on media drive 140 for execution, playback, or the like. Hard drive 138 may be connected to system bus 121 by a memory interface such as memory interface 134. Universal serial bus (USB) flash drive 154 and media drive 140 may be connected to the system bus 121 by memory interface 135.

As shown in FIG. 1, the drives and their computer storage media may provide storage of computer readable instructions, data structures, program modules, and other data for computer 141. For example, hard drive 138 may store operating system 158, application program 157, program module 156, and program data 155. These components may be or may be related to operating system 125, application program 126, program module 127, and program data 128. For example, program module 127 may be created by computer 141 when computer 141 may load program module 156 into RAM 160.

A user may enter commands and information into the computer 141 through input devices such as keyboard 151 and pointing device 152. Pointing device 152 may be a mouse, a trackball, a touch pad, or the like. Other input devices (not shown) may include a microphone, joystick, game pad, scanner, or the like. Input devices may be connected to user input interface 136 that may be coupled to system bus 121. This may be done, for example, to allow the input devices to communicate with processing unit 159. User input interface 136 may include a number of interfaces or bus structures such as a parallel port, a game port, a serial port, a USB port, or the like.

Computer 141 may include graphics processing unit (GPU) 129. GPU 129 may be connected to system bus 121. GPU 129 may provide a video processing pipeline for high speed and high-resolution graphics processing. Data may be carried from GPU 129 to video interface 132 via system bus 121. For example, GPU 129 may output data to an audio/video port (A/V) port that may be controlled by video interface 132 for transmission to display device 142.

Display device 142 may be connected to system bus 121 via an interface, such as a video interface 132. Display device 142 may be a liquid crystal display (LCD), an organic light-emitting diode (OLED) display, a touchscreen, or the like. For example, display device 142 may be a touchscreen that may display information to a user and may receive input from a user for computer 141. Computer 141 may be connected to peripheral 143. Peripheral interface 133 may allow computer 141 to send data to and receive data from peripheral 143. Peripheral 143 may include an accelerometer, an e-compass, a satellite transceiver, a digital camera (for photographs or video), a USB port, a vibration device, a television transceiver, a hands free headset, a Bluetooth® module, a frequency modulated (FM) radio unit, a digital music player, a media player, a video game player module, a speaker, a printer, or the like.

Computer 141 may operate in a networked environment and may communicate with a remote computer, such as computer 146. Computer 146 may be a computer, a server, a router, a tablet, a smart phone, a peer device or other network node. Computer 141 may communicate with computer 146 using network 149. For example, computer 141 may use network interface 137 to communicate with computer 146 via network 149. Network 149 may represent the communication pathways between computer 141 and computer 146. Network 149 may be a local area network (LAN), a wide area network (WAN), a wireless network, a cellular network, or the like. Network 149 may use Internet communications technologies and/or protocols. For example, network 149 may include links using technologies such as Ethernet, IEEE 802.11, IEEE 806.16, WiMAX, 3GPP LTE, integrated services digital network (ISDN), asynchronous transfer mode (ATM), or the like. The networking protocols that may be used on network 149 may include the transmission control protocol/Internet protocol (TCP/IP), the hypertext transport protocol (HTTP), the simple mail transfer protocol (SMTP), the file transfer protocol (FTP), or the like. Data exchanged may be exchanged via network 149 using technologies and/or formats such as the hypertext markup language (HTML), the extensible markup language (XML), or the like. Network 149 may have links that may be encrypted using encryption technologies such as the secure sockets layer (SSL), Secure HTTP (HTTPS) and/or virtual private networks (VPNs).

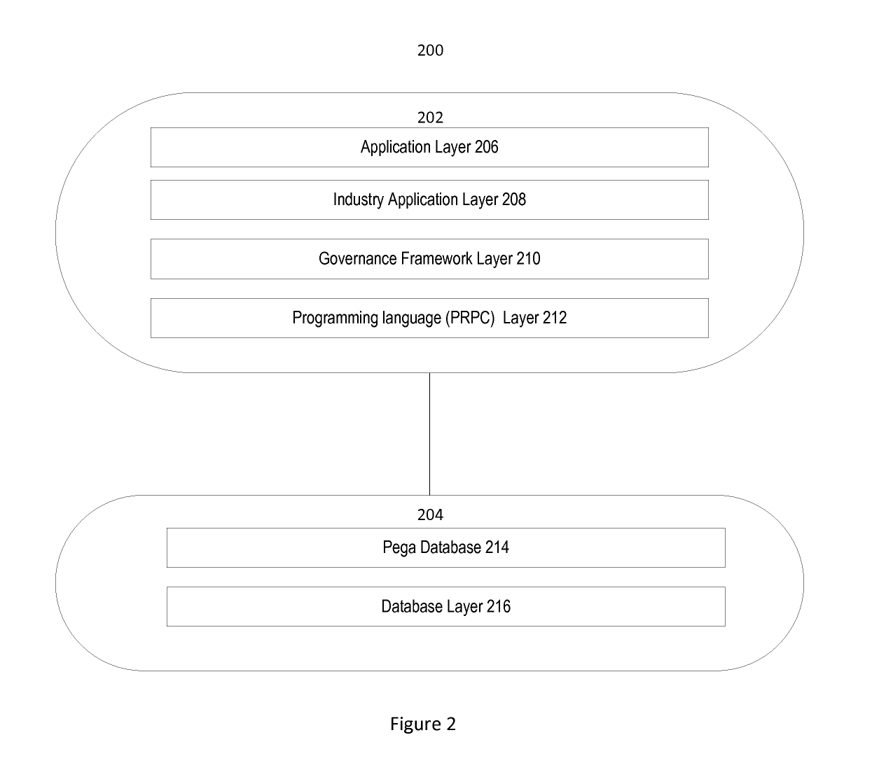

FIG. 2 depicts an example software architecture that may use a governance framework. The software solution 200 may be a business process management solution. The software solution 200 may include an application stack such as the application stack 202 and may include a database stack such as the database stack 204.

The applications stack 202 may include a number of layers such as an application layer, an industry application layer, a governance layer, an application programming interface layer, a programming layer, a combination thereof, or the like. For example, application stack 202 may include the application layer 206, the industry application layer 208, the governance framework layer 210, and the programming language layer 212 layer 212.

The programming language layer 212 may be a programming language that may or may not be native to BPM software. The programming language layer 212 may be a PRPC layer. For example, the programming language layer 212 may be a PRPC layer that may be used to interface with a BPM software platform such as those designed by Pega Systems (e.g. Pega 7).

The programming language layer 212 may be a layer that may be used to communicate with a database stack 204 and/or develop an application that may be used in the application stack 202. For example, the program language layer 212 may be a PRPC layer. The PRPC layer may be used to design software applications that may run within the application stack 202. The software applications designed with PRPC may interact with the database stack 204, for example, to retrieve and/or receive data from a database.

The programming language layer 212 may be a programming language that may be native to a BPM suite. The programming language layer 212 may be a procedural based programming language. The programming language layer 212 may be a declarative rule based programming language. For example, the BPM suite may be a BPM from PegaSystems and the programming language layer 212 may be a PRPC layer. The programming language layer 212 may be a programming language that may not be native to a BPM suite. For example, the BPM suite may by a BPM from Pegasystems and the programming language layer 212 may be Java. Developers may use a programming language, which may or may not be native to the BPM suite, to write applications that may be within the application stack and may interact with the database stack. For example, developers may develop a software program in Java that may use a Pega Systems BPM suite, such as P7.

The governance framework layer 210 may enforce practices and/or guardrails that may assist in reducing bugs or errors introduced into application stack 202 and/or database stack 204. The governance framework may ensure that developers are following best practices, for example, by preventing developer from checking in code that may have violations and/or errors. The governance framework may ensure that code may be in adherence with guardrails, for example, by monitoring developer activity and identifying potential issues. The governance framework may ensure that a development team works efficiently, for example, by providing a velocity report for the development team. The velocity report may show that performance of the team for a task. The governance framework may reduce defect rates for a software program that may be developed. For example, the governance framework may improve the quality of software while decreasing development time by catching potential defects. The governance framework may ensure that the software product may be able to scale in the future. For example, the governance framework may monitor code that may result in orphaned objects and/or wasted memory. The governance framework may analyze a software program to determine how the program may perform with an increased load. For example, the governance framework may monitor usage and may provide health reports for the software. The governance framework may analyze a software product to determine how that product may react with multiple applications.

The governance framework layer 210 may operate between the programming language layer 212 and an application layer, such as the industry application layer 208 and/or the application layer 206. This may be done, for example, to ensure that developers may efficiently create software using the application layer 206, industry application layer 208, programming language layer 212, and/or the database stack 204. For example, the governance framework may use a PegaRule process commander design such that the governance framework may be used with Pegasystem BPM software, such as P7. When used with Pegasystem software, the governance framework may improve the quality, compliance, and delivery of code in a PRPC development environment even though the software may be written in a language that may not be native to the Pegasystem software, such as the Java programming language. The governance framework may do this before the code may be translated from the procedural based programming language to a native programming language, which may be a declarative rule based programming language. For example, the governance framework may monitor code written in Java, may detect errors in the Java code, and may recommend how to correct the errors. The governance framework may prevent Java code that may include errors into PRPC. The governance framework may notify a developer that the Java code may need to be corrected and may recommend corrections to the developer.

The governance framework may audit software to find and/or prevent defects. The governance framework may provide an approval cycle for failed audits to coordinate the efforts of large development teams or to control changes to applications. The governance framework may provide developers with warnings, rule views, metrics, a combination thereof, or the like.

The industry application layer 208 may be a software solution that may be designed to support an industry. For example, industry application layer 208 may automate and speed up development or institute best practices. The industry application layer 208 may be design to operate on a BPM platform and may integrate with customer relationship management (CRM) software. The CRM software may or may not be part of the BPM platform.

The application layer 206 may be software that may process data. For example, the application layer may be insurance software that may process an insurance claim. There may be multiple applications, which may inherit a common framework.

The database stack 204 include data that may be used by the application stack 202. For example, database stack 204 may include data that may be used by application layer 206, industry application layer 208, governance framework layer 210, and/or programming language layer 212. The database stack 204 may include pega database 214 and/or database layer 216.

The Pega database layer 214 may be a database, which may include a Pega Database. Within Pega database layer 214 there may be a collection of tables that house rules. These rules may be stored as xml files in various tables along with metadata. To ensure platform independence, a DB layer, such as database layer 216, may be introduced so that the platform (PRPC) may work on multiple DB engines if such as SQL Server, DB2, Oracle, and the like.

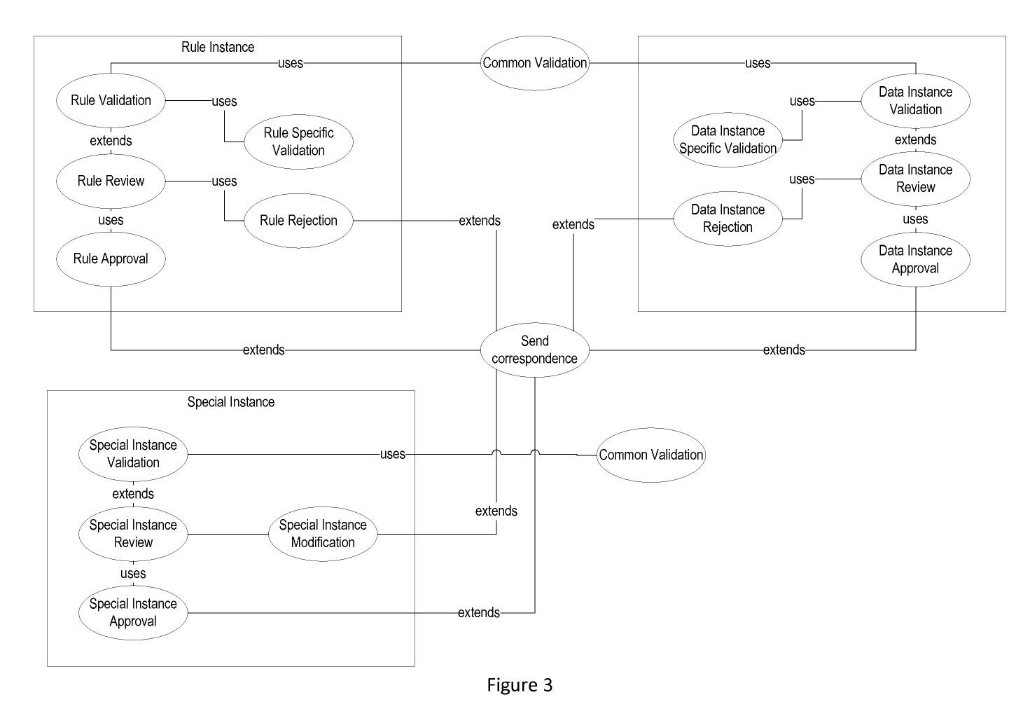

FIG. 3 illustrates a diagram for a governance framework. The governance framework may be designed to facilitate the development of software that may use a BPM as a platform. For example, a customer software solution may be built on top of a BPM, such as the Pegasystems BPM. The governance framework may be configured to enable checked-in approval for a rule set version. When a rule is checked in, the governance framework may create a work object and may route a review task to a workbasket, such as a CheckInCandidate workbasket. A reviewer may be assigned to this workbasket and may be tasked with reviewing tasks assigned to that workbasket. For example, the reviewer may review a rule and may approve or reject the rule. If the rule is rejected by a reviewer, the governance framework may check out the rule and may send a notification to the individual that may have created the rule. If the rule may be approved by the reviewer, the rule may be checked in to the relevant rule set version.

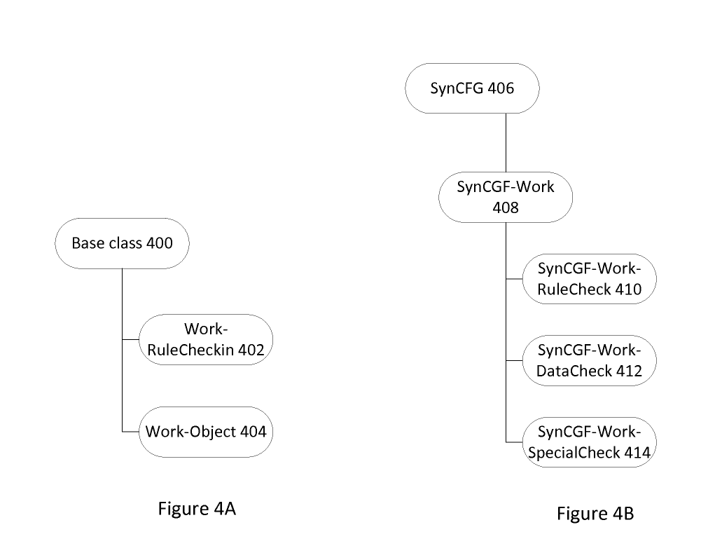

FIG. 4A depicts a 4B depicts class structures that may be used to implement a governance framework. FIG. 4A may be a class structure that may be used by a BPM platform. The class structure may include the base class 400, which may include one or more subclasses. The one or more subclasses may include Work-RuleCheckIn 402 and/or Work-Object 404. Base class 400 may be a base class that may be used the BPM platform. Work-RuleCheckIn 402 may be a class designated by the BPM platform. The Work-RuleCheckIn 402 class may be used for rules associated with the BMP rule approval process. For example, the Work-RuleCheckIn 402 class may be used by the BPM to manage changes to the approve rule flow. Work-Object 404 may be a class designated by the BPM platform.

FIG. 4B may be a class structure that may be used by a governance framework. The class structure may allow the governance framework to be implemented using a BPM platform. The class structure may include a number of classes such as the SynCFG 406. The SynCFG 406 may include a number of subclasses such as the SynCFG-Work 408 class, the SynCFG-Work-RuleCheck 410 class, the SynCFG-Work-DataCheck 412 class, and the SynCFG-Work-SpecialCheck 414 class. The SynCFG 406 class may be a base class of a BPM platform, such as the base class 400.

The SynCGF-Work 408 class may include a number of subclasses such as the SynCGF-Work-RuleCheck 410 class, the SynCGF-Work-DataCheck 412 class, the SynCGF-Work-SpecialCheck 414 class, or the like. The SynCGF-Work-RuleCheck 410 class may create the work objects and related information related to rules that may request approval from a technical lead. The SynCGF-Work-RuleCheck 410 class may have a pattern inheritance that may be to the Work-RuleCheckIn class 402 and may extend the functionality of the Work-RuleCheckIn class 402. Warnings related to rules that may belong to a ruleset and/or a ruleset version may fall under the SynCGF-Work-RuleCheck 410 class. For example, a property of a rule (e.g. Rule-Obj-Property) may fall under the SynCGF-Work-RuleCheck 410 class.

The SynCGF-Work-DataCheck 412 class may contain work object information pertaining to the data instances that may request approval from a technical lead. Rules that may be derived from the Data Class may be belong to the SynCGF-Work-DataCheck 412 class (e.g. Data-Admin-WorkBasket). The Data Class may allow data instances, such as work baskets, to derive information from the class or within the framework. The SynCGF-Work-DataCheck 410 class may have a pattern inheritance that may be to the Work-Object class 404 and may extend the functionality of the Work-Object class 404.

The SynCGF-Work-SpecialCheck 414 may contain work object information that may relate to special instances. The SynCGF-Work-RuleCheck 414 class may have a pattern inheritance that may be to the Work-Object class 404 and may extend the functionality of the Work-Object class 404. A special instance may be a rule instance that may have an associated ruleset, but may not belong to a ruleset version. For example, a property of a rule (e.g. Rule-Obj-Class) may call under the SynCGF-Work-SpecialCheck 414 class.

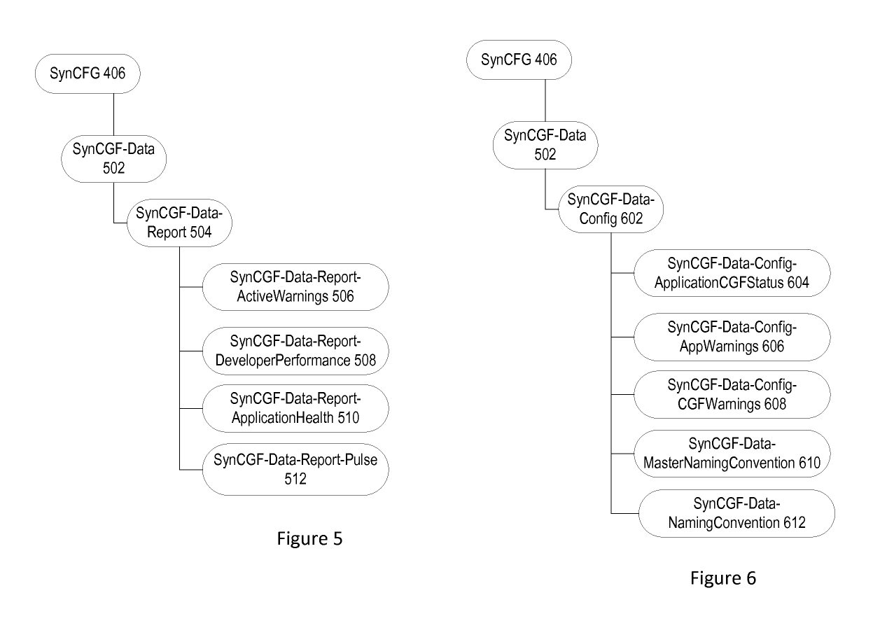

FIG. 5 depicts a class structure that may be to implement reporting for a governance framework. As shown in FIG. 5, the SynCFG 406 class may include a number of classes and subclasses. For example, the SynCFG 406 class may include the SynCFG-Data 502 class, the SynCFG-Data-Report 504 class, the SynCFG-Data-Report-ActiveWarnings 506 class, the SynCFG-Data-Report-DeveloperPerformance 510 class, the SynCFG-Data-Report-ApplicationHealth 510 class, the SynCFG-Data-Report-Pulse 512 class, or the like.

The SynCFG-Data 502 class may be an internal class for the framework and may provide functionality for the framework. For example, the SynCFG-Data class may provide warnings, violations, conventions, statuses, or the like. SynCFG-Data 502 may include the structure for the data of the framework. For example, when someone violates a rule, the warning may come from an object in SynCFG-Data 502. The SynCFG-Data 502 class may include a declare page (e.g. Declare_CGFAppWarnings). The declare page may be a node level declare page. A declare page may load reusable data into memory and may be separate from the cache.

The node level declare page may include warning related information for an application. The node level declare page may include the application list that may be present in the application. An activity, such as the LoadCFGApplicationWarning activity, may be used to load the declare page. For example, LoadCFGApplicationWarning may be used to load the reusable data from the DB into memory. The declare page may include a number of sub classes such as a CGFAppStatusList, a CGSAppWarningList, a CGFNamingConventionList, or the like. The CGFAppStatusList may be a page group that may include information about an application such as the application name, application version, or the like. The CGFAppStatusList may indicate whether the application may or may not be active. The CGFAppWarningsList may be a page group that may include warning information related to an application. A warning in the CGFAppWarningsList may include an application name, a version, a warning code, a combination thereof, or the like. The CGFNamingConventionList may include naming related information. Naming related information in the CGFNamingConventionList may include an application name, a version, a class name, a combination thereof, or the like.

The SynCFG-Data-Report 504 class may be used to store data for a report that may be generated by the governance system. The report that may be generated by the governance system may indicate the health of the software being developed, the performance of the software team that may be developing the software, errors that may have been discovered in the software, a combination thereof, or the like.

The SynCFG-Data-Report-Pulse 512 class may be used by a pulse agent to store warnings with their status in the application. The Pulse agent may be an asynchronous piece of code that runs in the background at a scheduled time. For example, the Pulse agent may be written to run once in 24 hours and may capture the development active and feed into the pulse table so reports may be run on the pulse table.

The SynCFG-Data-Report-ActiveWarnings 506 class may include information about warnings that may have been generated, for example, at the time the code was checked in. The warnings may persist in the database. The SynCFG-Data-Report-DeveloperPerformance 510 class may be used to store warnings that may have been generated for a developer. For example, a developer may have written code that may include an error. When the developer attempts to check in the errant code, the governance framework may issue a wearning for the developer and the warning may be stored within the SynCFG-Data-Report-DeveloperPerformance 510 class. The SynCFG-Data-Report-DeveloperPerformance 510 class may be used to determine how many warnings a developer may have received, may be used to determine the quality of code written by the developer, may be used to determine the performance of the developer, or the like. The SynCFG-Data-Report-DeveloperPerformance 510 class may be used by a pulse agent. The SynCFG-Data-Report-ApplicationHealth 510 class may be used to depict the current health of an application, for example, based on the number of warnings generated.

FIG. 6 depicts a class structure that may be used to implement configuration settings for a governance framework. As shown in FIG. 6, the SynCFG 406 class may include a number of classes and/or subclasses. For example, the SynCFG 40 class my include the SynCGF-Data 502 class, the SynCFG-Data-Config 602 class, the SynCGF-Data-Config-ApplicationCGFStatus 604 class, the SynCGF-Data-Config-AppWarnings 606 class, the SynCGF-Data-Config-CGFWarnings 608, the SynCGF-Data-Config-MasterNamingConvention 610, the SynCGF-Data-Config-NamingConvention 612, or the like.

The SynCGF-Data-Config-ApplicationCGFStatus 604 class may hold the governance framework status that may indicate if the governance framework is active or inactive for the application. The SynCGF-Data-Config-AppWarnings 606 class may include a warnings table, which may be a master warning table that includes all the warnings related information. The SynCGF-Data-Config-CGFWarnings 608 may be a table that may hold warnings that may be active for an application. The SynCGF-Data-Config-MasterNamingConvention 610 may be a naming conventions table that may include default naming standards. The SynCGF-Data-Config-NamingConvention 612 may hold naming conventions that may be associated an application.

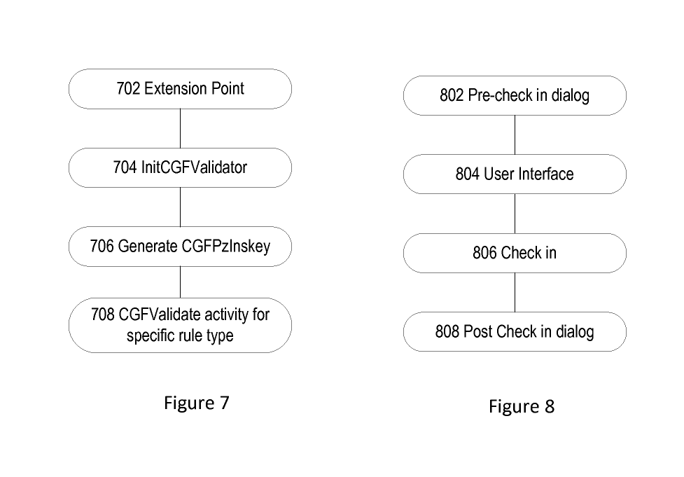

FIG. 7 depicts a diagram that may be used to provide a rule instance validation for a governance framework. For example, the diagram may be used to functions that may be used for rule instance validation such as rule check, quick create, save, circumstance, bulk checkin, or the like.

Rule instance validation may be provided by extending the functionality of a BPM platform. For example, at 702, the extension point, which may be a Pega extension point may be used to extend the BPM platform functionality to provide rule instance validation. The extension point 702 may be an activity or function, such as an InitCGFValidator activity, that may be a starting point for rule instances that may be validated for the governance framework. A class property may be provided to allow custom warnings to be generated for a rule. For example, the class property, which may be a CGFCustomWarnings class, may be created under SynCGF-Work 406 class to hold the warnings related information. This class property may map to a data class such as the SynCGF-Data-Report-Pulse 512 class. At 702, the extension point may be overridden such that the activity in a rule set, such as a SynCGF Ruleset, may be used to invoke governance framework related activities.

At 708, the InitCGFValidator activity may check whether governance framework may or may not be enabled for an application. This may be done, for example, by checking if the application name may be present. The SGF may have functionality where on selected applications may be enabled for validation check. This functionality may ensure that applications may not request the SGF footprint in the higher environments. The initCGFValidator activity may initialize various parameters and may conduct a check as whether the current application may be processed by SGF. If the governance framework is enabled, validation may proceed. If the governance framework is not enabled, then validation may not proceed.

At 706, key may be generated for the instance. For example, CGFGeneratePzInskey may be called to generate a key for the instance. At 708, the CGFCommonValidate activity may be called to validate common validations. For example, at 708, it may be determined if the request to validation may have been called on data, a rule, or a special instance. If it is determine that the request is a request for rule validation, then a rule warning check, such as PreRuleWarningsCheck, may be called. The rule warning check, which may be PreRuleWarnings check, may determine that the rule to be validated may need to be approved. The rule warning check may determine the type of rule that has been requested to be validated and may validate the rule to be validated according to the determined rule type. For example, a CGFValidate activity may be called according to the determined rule type.

A CGFValidate activity may be present in a number of class levels. The relevant class level for an instance may call CGFValidate from a PreRuleWarningsCheck activity. The CGFValidate activity may contain warnings that may be applicable to the rule type of the rule to be verified. The CGFValidate activity may call a CheckWarningAvailability activity to determine if a warning may be present in a declare page and if the warning may be active. The CGFValidate activity may determine if a standard has been violated. If the CGFValidate activity determines that a standard has been violated, the CGFValidate activity may call an AppendCGFWarningforWO activity. The AppenedCGFWarningforWO activity may create a page that may include warning details. The AppenedCGFWarningforWO activity may check if the severity of the warning, which may be a high severity, a medium severity, a low severity or the like.

The governance framework may use the CGFValidate activity to validate a rule. For example, using a CGFValidate activity, the governance framework may set the warning code for a rule violation. The governance framework may determine if a warning may be active for an application. This may be done, for example, by passing the warning code. If the warning is active, then the governance framework may check if the rule may have been violated by a developer. This may be done, for example, by checking the values on a rule page.

The governance framework may include procedures for a rule check in. When a developer checks in a rule, warnings may be generated. The generated warning along with their severity levels may be displayed in a check in modal window. A warning may be displayed in a rule form. For example, using a Pega BPM platform, a warning may be displayed in a rule form by appending the warning to a Pega warning property, such as the pxWarnings property, using an OnBeforeDisplay activity. A warning may not be displayed if the warning may have been approved. A table, such as SynCGF-Data-RuleTransaction, may be used to maintain keys (e.g. a record identifier such as CGFpzInskey and/or pzInskey), an application name, a warning status of a rule instance, or the like. A previously rejected warning may be marked as such. For example, a previously rejected warning may be marked as “rejected” in the description of the warning. If the rule the developer checks in may include a high severity warning, the rule may be checked into a ruleset such as the CheckInCandidates ruleset.

The governance framework may allow a developer to use the rule check in procedures to rectify a warning, open a work object, or the like. For example, a developer may be able to rectify a warning by clicking on a “cancel” button. As another example, a developer may click on an “ok” to create a work object. A pagelist may also be checked to determine if warning may be or may be associated with a high severity warning and/or a relevant action. This may be done, for example, using a WBApproval_CheckIn activity. This may provide a developer with the option to checkin code with warnings, or to fix a warning and try again.

The governance framework may allow a rule to be saved using, for example, a quick save function. A rule being saved for the first time or quick create may be clicked for certain rule types. An extension point, which may be the extension point called at 702, may be used provide a procedure for saving a rule. For example, @baseclass.pyPostSave may be used as the extension point. InitCGFValidator, which may be the InitCGFValidator called at 704, may be called to check if there may be a high severity warning in the rule. If high severity warnings may be present an Obj-Save-Cancel entry may be made to reverse the last save, a Page-Set-Message may be done to the rule page, which may set an error message on the rule, and the error message may be displayed to the user in the rule form. If high severity warnings may not be present no or only high severity warnings are present, the warnings may be saved to a pulse table (e.g. calling a Rule-UpdatePulseTable activity), which may be where warnings that relate to a rule may be saed, and BPM platform functionality may be used to check in the rule.

The governance framework may allow a rule to be saved using, for example, a save as function. A rule may be saved to a different version or with a different name. An extension point, which may be the extension point called at 702, may be used to provide a save as function. For example, Rule-.pyPostSaveAs may be used as the extension point. If a rule may be saved as from a checked in rule, an entry may be made in a pulse table, warnings may be copied from the checked in rule, and BPM platform procedures may be used to check in the rule. If a rule may be saved as from a checked out rule, InitCGFValidator, which may be the InitCGFValidator called at 704, may be called to check if the rule may include a high severity warning. If high severity warnings may be present an Obj-Save-Cancel entry may be made to reverse the last save, a Page-Set-Message may be done to the rule page, and the error message may be displayed to the user in the rule form. If high severity warnings may not be present no or only high severity warnings are present, the warnings may be saved to a pulse table (e.g. calling a Rule-UpdatePulseTable activity), and BPM platform functionality may be used to check in the rule.

The governance framework may allow a rule to be circumstanced. Circumstancing may be a requested aspect of Pega. For example, if there may be a process to reserve hotel rooms and based on your status you may get a discount. The reservation agent may not need to review the status of a user to determine the discount. Rather, the discount may be calculated based on the status of the user. This may be accomplished by creating 3 versions of the same rule, and circumstancing on the status property such that the value of the discount may be tied to a status.

An extension point, which may be the extension point called at 702, may be used to provide a save as function. For example, Rule-.pyPostSaveAs may be used as the extension point. If a rule may be saved as from a checked in rule, an entry may be made in a pulse table, warnings may be copied from the checked in rule, and BPM platform procedures may be used to check in the rule. If a rule may be saved as from a checked out rule, InitCGFValidator, which may be the InitCGFValidator called at 704, may be called to check if the rule may include a high severity warning. If high severity warnings may be present an Obj-Save-Cancel entry may be made to reverse the last save, a Page-Set-Message may be done to the rule page, and the error message may be displayed to the user in the rule form. If high severity warnings may not be present no or only high severity warnings are present, the warnings may be saved to a pulse table (e.g. calling a Rule-UpdatePulseTable activity), and BPM platform functionality may be used to check in the rule.

The governance framework may provide bulk check in functionality such that one or more rules may be checked in. An extension point, which may be the extension point called at 702, may be used to provide a bulk check in function. For example, Rule-.pyPostSaveAs may be used as the extension point. If a rule may be saved from a checked out rule, InitCGFValidator, which may be the InitCGFValidator called at 704, may be called to check if the rule may include a high severity warning. If high severity warnings may be present a Page-Set-Message may be done to the rule page.

FIG. 8 depicts a diagram that may be used by a governance framework to check in a rule. As shown in FIG. 8 at 802, the governance framework may provide the developer with a pre-check in dialog. The pre-check in dialog may request information about the rule the developer may be attempting to check in. The pre-checkin dialog may provide the developer with information regarding the checkin procedure. At 804, the governance framework may provide the developer with a user interface, which may be used to checkin the rule. At 806, the governance framework may checkin the rule. For example, the governance framework may checkin the rule using an activity such as CGFCheckin. At 808, the governance framework may provide a post-checkin dialog after the rule has been checked in. The post-checkin dialog may confirm that the rule may have been checkedin and may provide information about the checked in rule.

The governance framework may modify the check in modal flow from the BPM platform. The governance framework may use a CGFWarningMsgs class to display warnings that may be related to the governance framework. This may be done, for example, by populating data from a pagelist such as the CustomWarningsList pagelist. A CGFActionCheckin section may be used to include CGFWarningMsgs sections and the ActionCheckin section which may be the OOTB checkin dialog box section. The flow action CGFCheckIn may refer to the CGFActionCheckin section.

For example, a developer works on a rule, and then decides to checkin the rule. During the Checkin process, the developer may see that may ask him to review a violations/warnings and enter a comment required for checkin. The developer may decide, if he should checkin the code or cancel the checkin process and work on the warnings. If the developer to checkin, the system may check the warnings, and may take actions, such as creating and routing a work object for lead approval, insert data into Pulse table, or the like. When a work object may be created, it may be routed to a lead based on availability for approval. The lead may review the object, and approve or disapprove. Disapprove may create the task for the developer and may send the rule back to a ruleset. For approval and correction tasks, service levels may be attached to the assignments to ensure that deadline sanctity may be maintained. On approval, the WO may be closed and the rule may be checked in and the pulse table may be updated. After correction, the rule may be checked in again.

The governance framework may update a pulse table activity that may allow warnings to persist. For example, the governance framework may use an activity to call Rule-.UpdatePulseTable activity which may copy warnings related information to a pulse table. The governance framework may call the Rule-.UpdateFlagIfNoWO activity if the rule may not include a warning. The governance framework may copy the rule and warnings related information to a workpage and may create an instance of an ApproveRuleChanges flow. The ApproveRuleChanges flow may be a process flow for the creation of a data instance work object. The governance framework may override the work class for approval process and the work flow used for approval process in the security tab of the ruleset form.

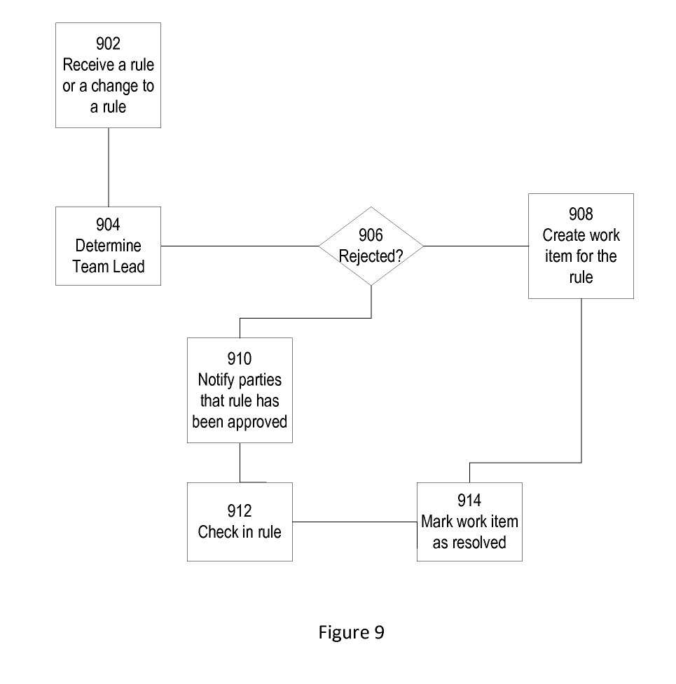

FIG. 9 depicts a diagram that may be used to by a governance framework to provide a rule approval process. The governance framework may allow a developer to create a rule, or change a previously created rule, that may help prevent a development team from introducing errors or bugs in to software. In some cases, a rule may need to be approved before the rule may be enforced and the governance framework may provide a process for approving the rule.

As shown in FIG. 9 at 902, the governance framework may receive a rule or a change that has been made to a rule. At 904, the governance framework may determine that the rule or the change to the rule may require the approval of a team lead. For example, the governance framework may load the team lead operator for a developer using an InitParties Utility, which may be used to setup profiles for developers and/or leads. The governance framework may assign the rule to the team lead and may present the rule to the team lead. For example, governance framework may include a team lead user interface that may include a common information tab and a warnings information tab. The common information tab may display rule related information. The warnings information table may display warnings that may be generated for the rule created by the developer.

At 906, the team lead may approve or disapprove of the rule. The team lead may approve of the rule, for example, by approving each warning related to the rule. At 910, the team lead may approve of the rule and the governance framework may notify interested parties that the rule may have been approved. For example, the governance framework may notify the creator of the rule that the rule has been approved. For example, if the warnings are approved, an approved email correspondence may be sent to a developer with comments from the team lead and the work object status may be marked as resolved. A team lead may be able to bulk approve work items. For example, the team lead may indicate to the governance framework that a number of items may be approved. The governance framework may open the work object for the items, process the items, and mark the items as approved.

At 912, the governance framework may check in the rule and may apply the rule to code being developed. For example, the governance framework may check the rule into a ruleset that may be applied to an application being developed.

At 908, if the team lead does not approve of the rule, the governance framework may receive information from the team lead and may create a work item for the rule. For example, if the team lead rejects a warning related to the rule, the governance framework may request comments from the team lead and may assign the rule back to the developer that created the rule. A team lead may be able to bulk rejected work items. For example, the team lead may indicate to the governance framework that a number of items may be rejected. The governance framework may open the work object for the items, process the items, and mark the items as rejected. At 914, the governance framework may make the received rule or the received changed to the rule as resolved.

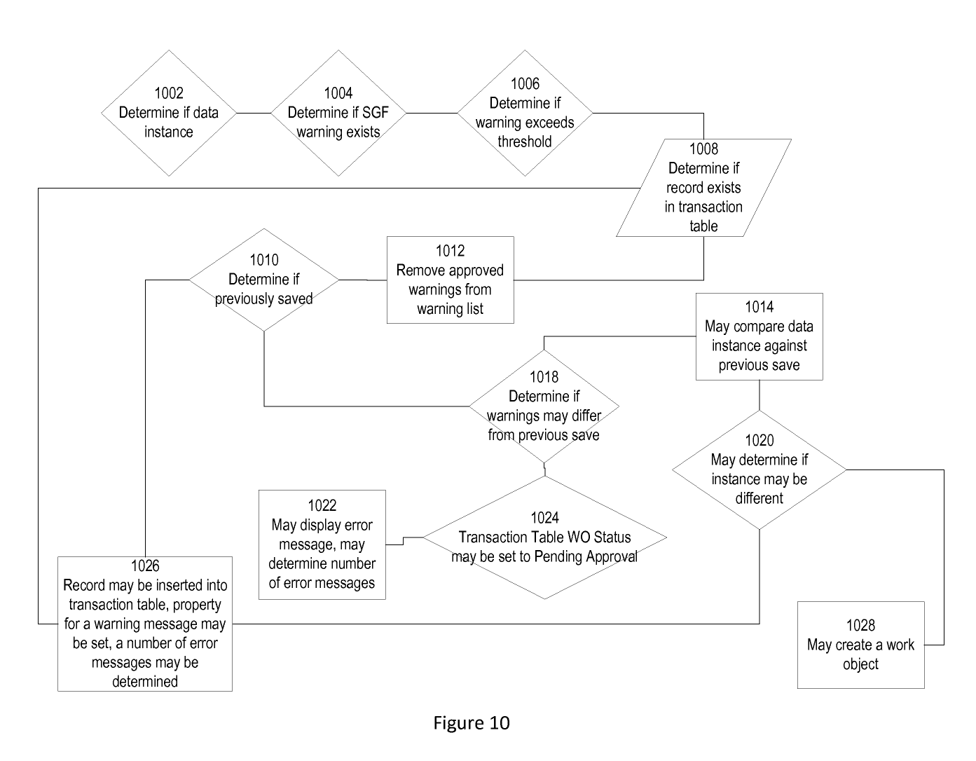

FIG. 10 depicts a diagram that may be used by a governance framework to provide data instance validation. The data instance validation process shown in FIG. 10 may cater to most of the data instances of a BPM system. The process may check that data instances adhere to the validations that may be activated for an application. A separate data table may be maintained for items that pertain to data instances such as a status, a warning, a workobject ID, or the like.

A validation process may start when a data instance may breach a validation beyond a certain threshold. A developer may be notified about the warning, for example, during a save. The developer may be given a chance to correct the warning to make data instance compliant to existing rules or to send the same data instance to a tech lead for approval. If the developer does not correct the warning and may wish to adhere to the same configuration, then a work item may be created and may be routed to the tech lead for approval along with the data instance information. The developer may be notified about the rule in a rule form. If the tech lead may approve the data instance, the data instance may be created in the system and the developer may be notified, for example, via email. If the tech lead may reject the data instance, the developer may be notified and the developer may be provided with rejection comments.

The Data Instance validation may include a number of levels. For example, a level may include a PreSave (@baseclass) activity, which may be a CGF extension point for data instance validation. A InitCGFValidator activity may be called. A preDIWarningsCheck activity, which may be the Primary Activity for Data Instance) referred inside InitCGFValidator may be called. InitCGFValidator may start the execution of Data Instance validation. As another example, a level may include BPM platform validations such as Pega BPM platform validations. As another example, a level may include an onBeforeDisplay (@baseclass) Activity, which may be a may be a CGF extension point for data instance validation. A CGFonBeforeDisplay activity, which may include validation logic of rule and data instances, may be called. A DI_CGFonBeforeDisplay activity, which may be a primary data instance validation activity referred inside CGFonBeforeDisplay, may be called. The DI_CGFonBeforeDisplay activity may be called after a BPM platform performs validation. The DI_CGFonBeforeDisplay activity may determine whether the BPM platform indicates that to data instance may have a warning and/or error. For example, the DI_CGFonBeforeDisplay activity may determine whether the BPM platform indicates that the data instance may have an error when there may be a difference between an error message count for a previously saved version of a data instance and the error message count for the data instance. The DI_CGFonBeforeDisplay activity may determine if work object may have been created for a warning and/or error, and whether the work object may have been sent to a tech lead for approval.

A data table, such as SynCGF-Data-DataTransaction, may be used to maintain information for a data instance, such as the DatalnstanceKey, WarningsList, FirstSaveFlag, FirstSaveObject, DataInstanceStatus, DeveloperName, WorkObject ID, and the like.

A preDIWarningsCheck activity may include logical for handling a data instance validation process. The preDIWarningsCheck activity may use preconditions and transitions to handle the passing of control of the flow within the process. The preDIWarningsCheck may call a CGFValidate activity, which may perform a validation. If the data instance may not breach a validation, then a message count may be set to zero and the preDIWarningsCheck activity may end. If the data instance may breach a validation, an Obj-Open-By-Handle may be performed to check whether record may exist. If a record may not exist, an InsertDIInformation activity may be called.

The InsertDIInformation activity may be used to information regarding a data instance to a transaction table. The information may include, for example, a data instance key, a warning list, an identity of a save object, a status for the data instance, a developer name, an identity of a work object, or the like. The InsertDIInformation activity may iterate warning in a page list and may create a first save list, which may be stored in the transaction table. The InsertDIInformation activity may perform a page-copy to copy the page of the data instance into a temporary page that may be used for processing. The InsertDIInformation activity may remove a pxUpdate property from the page. The page may be converted into a string through getXMLOfPage( ) function, the converted string may be sorted, and the sorted converted string may be compared to the first save data instance string. The InsertDIInformation activity may determine if a warning list may include a high severity warning and may determine if the high severity warning may have been approved. The InsertDIInformation activity may determine the number of errors that may be indicated by the warning list.

If record may exist, a RemoveApprovedWarnings activity may be called and it may be determined whether the data instance may have been previously saved. The RemoveApprovedWarnings activity may be used to remove already approved warnings from a warning list for a data instance. The RemoveApprovedWarnings activity may iterate a warning list and check whether a warning may be a high severity warning and whether the warning may have been approved. If the warning may have been approved, then the warning may be removed from the warning list.

If the data instance may not have been previously saved, the preDIWarningsCheck activity may end. If the data instance may have been previously saved, a CompareWarnings activity may be called. The CompareWarnings activity may be used to compare the warning that may have been populated between a first save and a second save. The CompareWarnings activity may iterate a warning list and may determine whether the warning may exist in a warning list for the second save.

If there may not be warnings be warnings and the instance status may not be “Pending-Approval,” a InsertDIInformation activity may be called. If warnings between the data instance and the previously saved data instance may not differ, a CompareInstances activity may be called. The CompareInstances activity may be used to compare the data instance information between a first save and second save to ensure any changes have been incorporated by developer. A Page-Copy may be performed to copy the instance page into a temporary page to continue the processing. A Property-Remove may be performed to remove pxUpdateDateTime property from the page. The page may be converted into a string through getXMLOfPage( ) function, converted string may be sorted, and the sorted converted string may be compared to the first save data instance string.

If the data for the data instance and the data for the previously saved data instance may differ, an InsertDIInformation activity may be called. If the data for the data instance and the data for the previously saved data instance may not differ, a CreateLeadWO activity may be called, which may create a work object that may be assigned to a tech lead. The CreateLeadWO activity may create a work objet after getting confirmation from a developer. The CreateLeadWO activity may copy a page that may include the data instance into a pyWorkPage, which may be a space in the memory where this object may be stored. The CreateLeadWO activity may copy information about createdData, CreateOperator, or the like into the pyWorkPage. The CreateLeadWO activity may send the data instance to a tech lead for approval and may send a notification to the developer that may have created the data instance. The CreateLeadWO activity may insert a record into a pulse table for the data instance.

At 1002 the governance framework may determine if a request for validation may request validation of a data instance. If the request is not for validation of a data instance, the governance framework may call a procedure to handle that validation. At 1004, if the request is for validation of a data instance, the governance framework may determine if a warning may exist. The warning may be a governance framework warning, a BPM platform warning, or the like. At 1006, the governance framework may determine if the warning may exceed a threshold. The threshold may be set such that a warning may be address when the warning exceeds a certain level, number of warnings, a combination thereof, or the like. For example, the threshold may be set five warnings may exceed the threshold. At 1008, the governance framework may determine if a transaction table includes a record for the data instance. If a record for the data instance does not exist within the transaction table, the governance framework may create a record for the data instance within the transaction table at 1026. If a record for the data instance does exist within the transaction table, the governance framework may remove warnings that may have been approved from the warning list at 1012. For example, the governance framework may remove warnings that may have been approved by a tech lead from the warning list.

At 1010, the governance framework may determine if the data instance may have been saved previously. If the data instance may not have been saved previously, at 1026 the governance framework may create a record, insert the record into the transaction table, set a property for a warning message, determine a number of error message, a combination thereof, or the like.

If the data instance may have been saved previously, at 1018, the governance framework may determine if the warnings for the data instance may different from the warnings for the previously saved version of the data instance. If the governance framework determines that the data instance may differ from the previously saved version of the data instance, at 1024, the governance framework may set the status for the data instance within the transaction table to “pending approval.” At 1022, the governance framework may display an error message and may determine the number of error messages.

At 1014, the governance framework may compare data from the data instance to data from the previously saved version of the data instance. If the governance framework may determine that the data instance may differ from the previously saved version of the data instance, at 1026, governance framework may insert a record into the transaction table, may set warnings, may count the warnings, and the like. If the governance framework may determine that the data instance may not differ from the previously saved version of the data instance, the governance framework may create a work object at 1028.

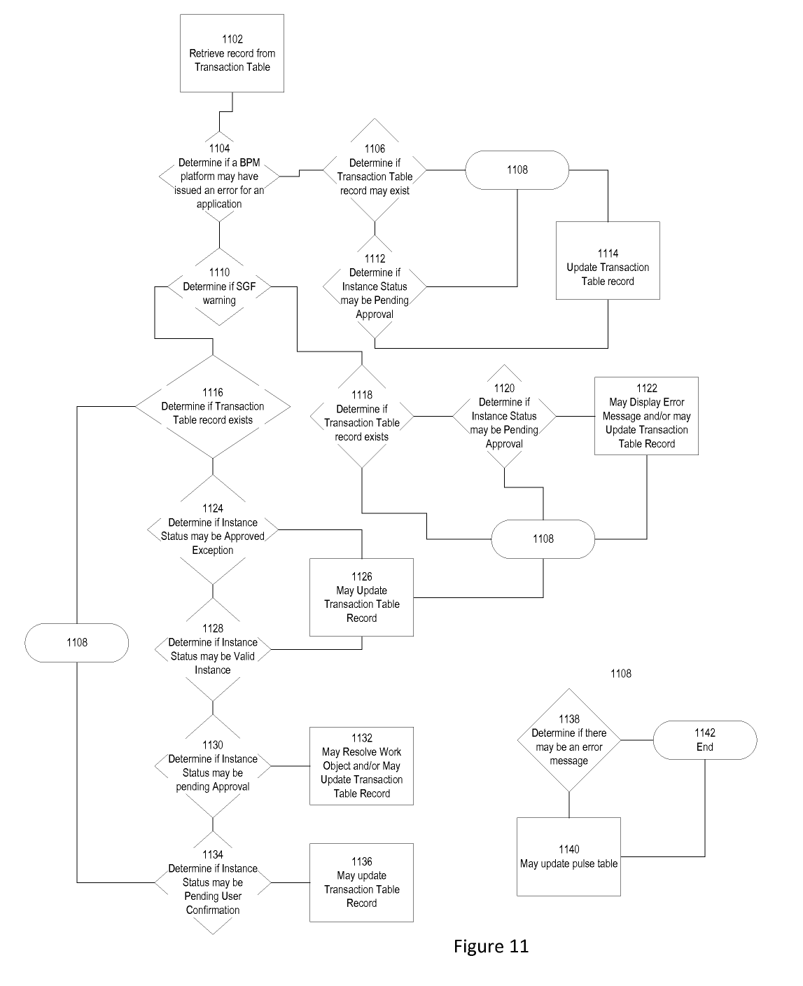

FIG. 11 depicts a diagram that may be used by a governance framework to provide data instance validation. For example, the process depicted in FIG. 11 may be performed after a validation may have occurred.

At 1102, the governance framework may retrieve a record from a transaction table. The record may be for a data instance. At 1104, the governance framework may determine if a BPM platform may have issued an error for an application. At 1106, the governance framework may have determined that the BPM platform may have issued an error for the application and may determine if a record for the error may exist in a transaction table. At 1112, the governance framework may have determined that a record for the error may exist and may determine if the status of the record indicates that the data instance may be pending approval. At 1114, the governance framework may update the record in the transaction table if the status of the record indicates that the data instance may be pending approval. At 1108 the governance table may update a pulse table. For example, the governance table may update a pulse table when a transaction table may not have a record for a data instance, or if the governance framework determines the status of a data instance may be marked as “pending approval.”

At 1108, the governance framework may perform a procedure that may update a pulse table. For example, at 1138, the governance framework may determine if there may be an error message. If there is an error message, the governance framework may precede end the update function at 1142. If there may not be an error message, the governance framework may update the pulse table at 1140.

At 1110, the governance framework may determine if a warning may have been generated by the governance framework. This may be done, for example, when the governance framework determines that a warning may not have been generated by the BPM platform. At 1118, if a warning may have been generated by the governance framework, the governance framework may determine if a record for the warning may exist in a transaction table. At 1120, the governance framework may determine if the record for the warning may indicate that the status for the data instance may be “pending approval.” At 1122, if the status for the data instance may not be “pending approval,” the governance framework may display error messages and/or may update a transaction table record.

At 1116, the governance framework may have determined that a warning may not have been generated by the governance framework and may determine if a record for the warning may exist in a transaction table. If the governance framework determines that a record may not exist, the governance framework may update a pulse table at 1108. If the governance framework determines that a record may exist, the governance framework may determine if the status of the data instance may be set to an “approved-exception.” This may mean that the framework identified a violation/exception, but the lead may have approved it. At 1128, the governance framework may determine if the status of the data instance may be set to a “valid instance.” At 1126, the governance framework may update a record in a transaction able if the status of the data instance may be an “approved-exception” or a “valid instance.”

At 1130, the governance framework may determine if the status of the data instance may be set to a “pending approval.” At 1132, when the status of the data instance may set to “pending approval,” the governance framework may resolve a work object and/or may update a record in a transaction table. At 1134, the governance framework may determine if the status of the data instance may be set to “pending user confirmation” and, at 1136, may update a record in a transaction table.

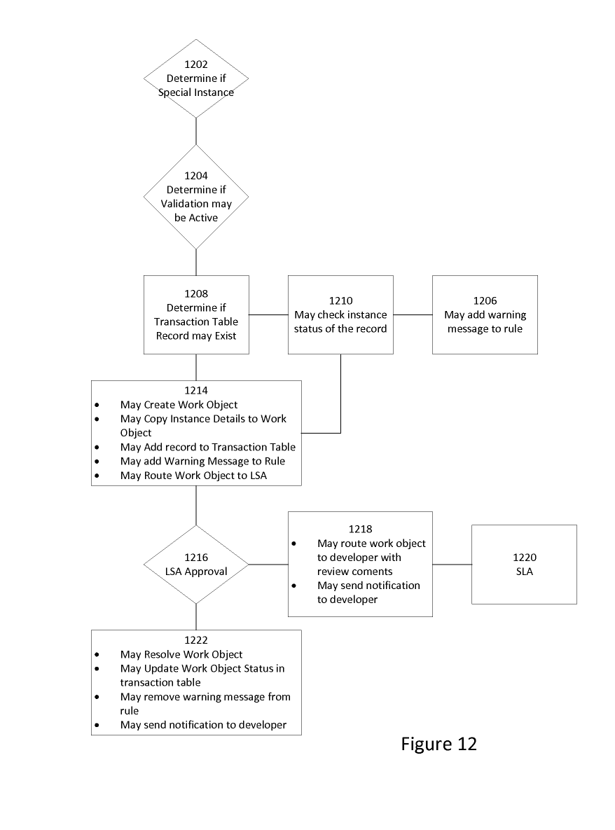

FIG. 12 depicts a diagram that may be used by a governance framework to provide special instance validation.

The governance may provide a special instance validation procedure, which may be used when a special instance may be created in an application. A special Instance may not be data or a rule. For example, a special instance may be a class, a ruleset, a ruleset version or the like. If special instance validations may be activated for the application, a user may be notified via a warning that a work object may have been created for the instance and approval may be requested from a tech lead. The tech lead may review the special instance and may approve the special instance. For example, the tech lead may approve the special instance such that a warning associated with the instance may be removed. A notification may be sent to a developer to notify the developer that the tech lead has approved the special instance. A work object may be resolved.

A tech lead may provide comments regarding the special instance and may request that the special instance may be modified. A work object may then be routed back to a developer along with comments from the tech lead. The developer may be notified, for example, via email that the work object has been assigned to the developer.

A special instance validation procedure may be triggered as a post action of an instance creation. If the BPM platform validation throws an error, then the special instance validation may be skipped. A CheckForCustomWarnings Activity may be used as an extension point for a special instance, which may call an InitCGFValidator activity. A PreSIWarningsCheck activity, which may be referred to within the InitCGFValidator activity, may be called. The PreSIWarningsCheck activity may be used during a special instance validation procedure. The PreSIWarningsCheck activity may call the CGFValidate activity that may determine whether validation for a special instance may have been enabled. The PreSIWarningsCheck activitycheck whether record for the special instance may exist in a transaction table. If a record may not exist, the PreSIWarningsCheck activity may call SIPendingApproval. If the record may exist, the The PreSIWarningsCheck activity may check the status of the instance. If status may be “open,” the PreSIWarningsCheck activity may create a warning message. For example, the message may indicate that the changes have been incorporated and that a work object may have been sent to a tech lead for approval. If the status may be “pending-approval,” If status may be “pending-approval,” the PreSIWarningsCheck activity may create a warning message. For example, the message may indicate that the changes have been incorporated and a work object is being reviewed by a tech lead. If status may be “resolved-completed,” the PreSIWarningsCheck activity may call a SIPendingApproval activity.

The SIPendingApproval activity activity may be used to create a work object for an instance. The SIPendingApproval activity may copy instance details to a work object, may add a warning message to a rule, and may add a record to a transaction table. For example, the SIPendingApproval activity may create a pyWorkPage for a flow and may remove errors. The SIPendingApproval activity may call a PopulateWOInfo activity to populate instance details. The SIPendingApproval activity may populate a transaction table record and a warning message.

A CleanUp activity may be used as an extension point for a special instance deletion, which may call a DeleteSpecialInstances activity. A data table, such as SynCGF-Data-DataTransaction, may be used to mainstain information about a special instance. The information may include a key for the data instance, a status for the data instance, a developer name, an identity of an object, or the like.

The creation of special instances may be restricted to a user role. For example, senior developers may be allowed to create special instances while junior developers may be prevented from creating special instances.

At 1202, the governance framework may determine if an instance may be a special instance. At 1204, the governance framework may determine if there may have a request to have the special instance validated. For example, the governance framework may determine that a validation property, which may trigger a validation, within the special instance may be set to “active.” At 1208, the governance framework may determine if a record for the special instance may exist within the transaction table.

At 1210, the governance framework may determine that a record for the special instance may exist. The governance framework may use the record to determine that status of the special instance. For example, the governance framework may determine that the status indicates that the special instance may be “pending approval,” “open,” “resolved-completed,” or the like. At 1206, a warning message may be added to the rule for the special instance. For example, the warning message may indicate that a work object may have been created and that the work object may have been sent to a tech lead for approval. As another example, the message may indicate that the changes may have been incorporated and may request that a work object be submitted for approval by a tech lead. As another example, the message may indicate that the changes may have been incorporated and that a work object may be reviewed by a tech lead.

At 1214, the governance framework may determine that a record for the special instance may not exist. The governance framework may create a work object, may copy the instance details of the special instance to the work object, or the like. The governance framework may create a record to a transaction table. The governance framework may add a warning message to a rule. The governance framework may assign a work object to a tech lead. This may be done, for example, to ensure that the work object may be approved by a tech lead.

At 1216, the governance framework may determine whether a work object that may be associated with a special instance may be approved by a tech lead. If the tech lead approved the work object, at 1222, the governance framework may resolve the work object. For example, the governance framework may update the status of the work object in a transaction table, may remove warning messages, may send a notification to a developer, or the like. If the tech lead did not approve the work object, at 1218, the governance framework may assign the work object to a developer, may provide the developer with comments from the tech lead, may send a notification the developer, or the like. At 1220, governance framework use an assignment level service rule to notify a developer of pending work. The SLA may ensure that the urgency of the task may be increased and the task may be highlighted in the work list so that the developer may to it and completed it within a goal time. This may apply to a lead for approving a work object and may ensures that the overall timeline of the development process may not be hampered.

The assignment level service rule may include a number of intervals that may be used to notify a developer. For example, the assignment rule may include a goal interval, a deadline interval, and a passed deadline interval. The goal interval may allow the governance framework to remind the developer to take an action if the developer does not correct an error within a rule within the goal interval time (e.g. 3 hours) of receiving the work. The deadline interval may allow the governance framework to remind the developer to take an action if the developer does not correct an error within the deadline interval. The passed deadline interval may allow the governance framework to remind the developer to take an action if the developer does not correct an error within the pass deadline interval.

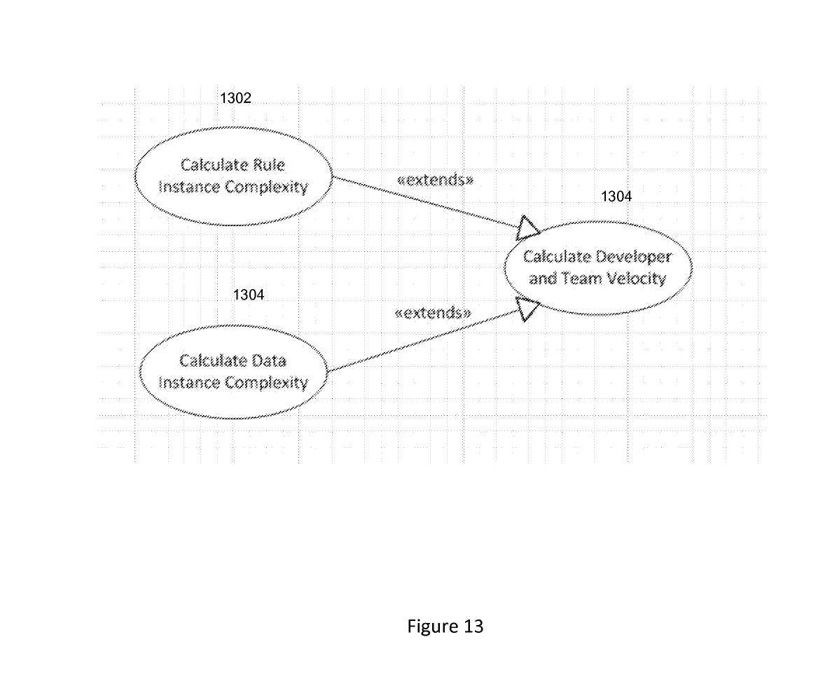

FIG. 13 depicts a method for calculating developer and/or team velocity. A plugin framework may be provided to enable Business and IT to work in conjunction to measure the individual developer performance and/or team performance. This may be used to compute the individual velocities of developers based on benchmarks for that rule type. This may allow a user to which developers may be the top developers associated with the application. This may also allow a user to assess the risk associated with a developer leaving the team.

The plugin may be a SynCGF Ruleset and may be included in in an application, which may be built on PegaRules. The plugin may provide be able to capture information such as rule information, development time, rule complexity, rule warnings, or the like from the system for rule instances and/or data instances. The plugin may be able to calculate developer and team velocity based on the captured information. The plugin may be able to benchmark a developer against a range. For example, a developer may be benchmarked against a range of 1-10 with 10 being the best performance. The plugin may be able to benchmark a team based on the teams accumulative velocity.

Referring to FIG. 13, the plugin may be able to capture rule complexity information. For example, rule complexity information may be captured. At 1302, rule instance complexity may be calculated. Data instance complexity may be calculated at 1302. Developer and/or team velocity may be calculated at 1302.

Complexity may be a unit of work that a developer may perform based on a rule. Complexity may be applicable for a rule type when the developer works on that rule. These units may be stored in a data table (e.g. SynCGF-Data-Velocity-RuleComplexity). In put may not be requested to measure complexity. A team lean may change the unit of complexity that may be assigned to the work done on a rule. Complexity may be calculated when a developer forms work on a rule. For example, changes may be captured and stored in a database table of a class (e.g. SynCGF-Data-Velocity-DevVelocity). The associated rule information may be captured and stored (e.g. SynCGF-Data-Velocity-RuleComplexity). This may happen at checkIn time for rule an instance and at save time for a data instance.

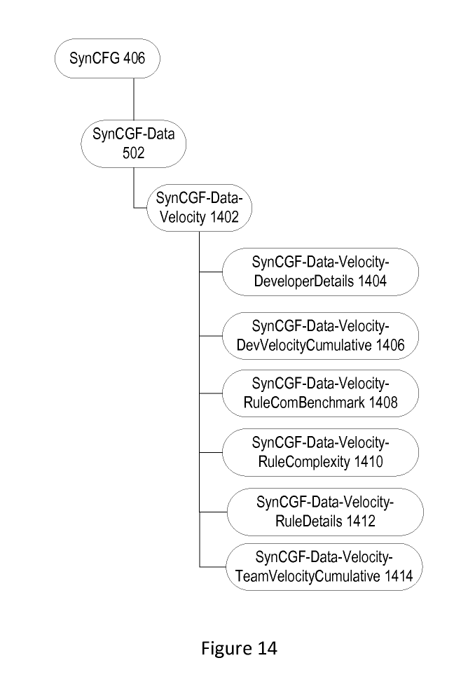

FIG. 14 depicts data classes that may be used for velocity calculation. SynCGF-Data-Velocity 1402 may be used for velocity calculation and may include a number of subclasses. SynCGF-Data-Velocity-DeveloperDetails 1404 may be mapped to a table, such as “CGF DEVELOPERS COMPLEXITY,” which may developer details along with developer earned complexity in the check-in time. SynCGF-Data-Velocity-RuleDetails 1412 may be mapped to a table, such as “CGF_RULES_COMPLEXITY,” and may hold rule details along with complexity values that may be assigned for the rule in the check-in time. SynCGF-Data-Velocity-DevVelocityCumulative 1406 may be mapped to calculated developer velocity and developer details. SynCGF-Data-Velocity-RuleComBenchmark 1408 may be used to to map rule accuracy benchmark values. Benchmark values may be considered when ranking a developer based on performance. SynCGF-Data-Velocity-RuleComplexity 1410 may be used to map complexity values for rule types and particals. SynCGF-Data-Velocity-TeamVelocityCumulative 1414 may have calculated team velocity values.

A SGF veleocity RuleSet may be place on top of other CGF Rulesets. If other SGF RuleSets may not exist in a server, than a velocity function may not be deployed. SynSGF and SynSGF-Authorization RuleSets may be deployed when used for a velocity deployment.

A declare page may be used to provide for rule complexity. For example, Declare_CGFRuleComplexity may be a declare page that may be crated to hold complexity values for rule types with the class of SynCGF-Data-Velocity-RuleComplexity. This declare page may be accessed to get complexity values for initial creation and particle values of a rule in check-in time.

A rule complexity list may be provided. A separate rule set may be provided. SGF velocity calculation feature may be a separate ruleset, along with SGF framework. Rules related to the velocity calculation may be stored in the SynCGFVelocity ruleset. This rule set may included or excluded into SGF framework.

Complexity values may be assigned for initial creation of a rule type and logics that may be added later on. For example, the creation of an activity rule may be set as shown in the following table:

| | |
|---|---|
| Initial Creation | 3 |
| Property-Set | 1 |
| Page-Remove | 1 |

An CGFExtensionPoint may be provided. This activity may be created in an @baseclass level in SynCGF ruleset and SynCGFVelocity ruleset. Activity which states in the SynCGF level may act as a place holder where it may not contain any code implemented, but it may have called CalculateComplexity activity which may be stated in the SynCGFVelocity ruleset level. This activity may be called in following scenarios for rule instance and data instances:

Rule Instances:
Rule CheckIn—(WBApproval_CheckIn)
Bulk CheckIn—PreCheckIn
Initial creation—pyPostSave
Save as—pyPostSaveAs

Data Instances:
Save—preSave

Special Instance:
Save—CheckForCustomWarnigs

Complexity may be calculated (e.g. CalculateComplexity) and may be created in a @baseclass level. A CGFComplexity activity may be called to evaluate complexity for a rule type and/or a data instance type. It may be inserted rule complexity and rule development time (difference between check-out and check-in time). Rule details and developer details may be into different tables.

CGFComplexity may have been crated in a place holder activity in a @baseclass level and may create rule level activities in a rule/data instance class level. For example:
Rule-Obj-Activity.CGFComplexity
Rule-Obj-Flow.CGFComplexity
Rule-Obj-Validate.CGFComplexity

Data that may be gathered in the rule check-in time and data instance save time may be considered for the velocity calculation for one or more developers. This process may be performed through an agent to reduce the performance overhead.

Benchmark velocity values may be considered for a rule type along with previously calculated data. Developer details may be retrieved based on allocated application, iterate through a created rule, get respective warning details, and apply velocity formula to calculate velocity. For example, the following equation may be used:

$$Developer Velocity = {\sum }_{i = 0}^{n} ( \frac{Developer Rule Complexity}{Actual Development Time} - ( \# Check \text{-} In * 0.5 ) - ( \# High Warnings * 0.5 + \# Medium Warnings * 0.3 + \# Low Warnings * 0.2 ) )$$

Performance of a developer may be calculated for a rule by comparing against a benchmark value for a rule type and determining an average. For example, the following equation may be used:

$$Developer Performance = \frac{{\sum }_{i = 0}^{n} ( \frac{Rule Developer Velocity}{Rule Benchmark} * 10 )}{Developer Created Rule Count}$$

Calculated developer velocity and developer performance records may be placed in tables and may be used for reports.

Team velocity and team performance may also be calculated, for example, using the following equations:

Team Velocity=Average of each developer velocity for a given application

Team Performance=Average of each developer performance for a given application

An action, such as GetCumulativeDevelopersVelocity, may be provided. This may be done, for example, to allow developer details to be retrieved, to interative through a developer list, and to save benchmark values if they may be changed for a rule type.

An action, such as getComplexityValueForDeveloper, may be provided. Tule details for a may be retrieved for a developer. A rule list may be interated to get a list of warnings and/or severity levels. Developer velocity may be calculated by applying rule complexity, rule development time, rule check-in count and/or warning details. Developer performance may be calculated based on developer velocity and/or rule benchmarks.

An action, such as getWarningRecordsforRule, may be provided to get warning records for a rule. A report definition rule may be access to get warning details. Warnings may be counted and may be passed back to the calling activity.

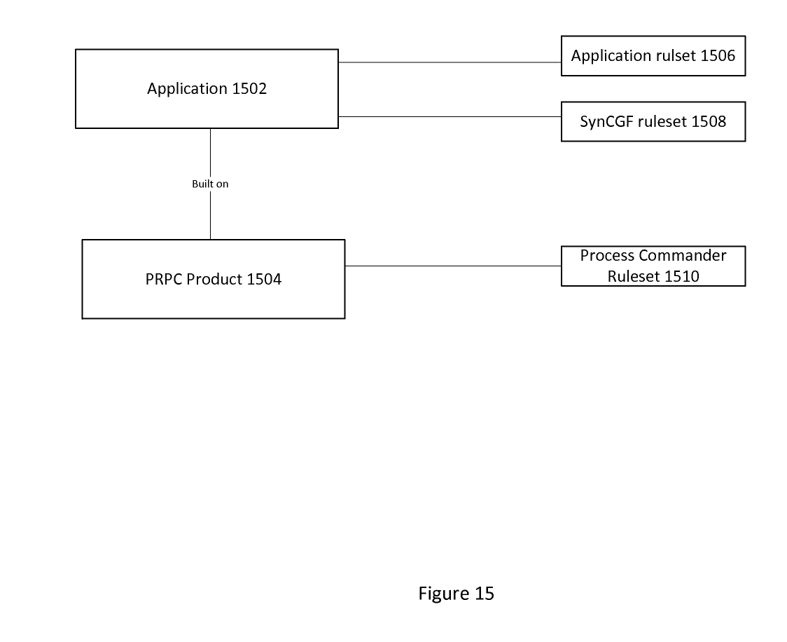

FIG. 15 depicts an example of an application with a governance framework (SGF) enabled. An admin portal may be provide. By logging into the SGF Admin portal using CGFAdmin credentials the admin user may an SGF enabled applications. Using this, the user may enable or disable applications in a server.

When the admin user enables SGF for an application, such as application 1502, a check may be made to see if the built on an application, such as PRPC product 1504 which may be PegaRules. When application 1502 may be located then a new version of application may be created and SGF ruleset at 1508 may be added to the application ruleset 1506. The referencing application rules may also be changed.

For example, when an admin selects and application and clicks on an enable SGF button, a SaveAppToCGF activity may be called. An entry may be inserted to the SynCGF-Data-Config-ApplicationCGFStatus table with the application name and status as active. Dynamic system setting DSS_CGFModifiedTime may be updated to refresh declare page at node level. The ActivateCGFApplication activity may be called.

The ActivateCGFApplication may open the selected application from the database. If the application may be built on PegaRules then the SynCGF related rulesets may be added to the application rulesets and the process may end. If the current application may be built on another application then it may will loop the application stack one by one by using the built on application until the built on application for the current application becomes PegaRules. When the built on application may become Pegarules, a check may be done to see whether a version exists for the current application. If it exists, a check may be made to see whether it contains the SGF ruleset. If it does not contain the ruleset, the ruleset may be added. The built on application for the previous application may then be changed.

If a version does not exist for the current application, then a version for the current application may be created and SGF rulesets may be added to it and this application may become the built on application for the previous application.

When the admin user disables SGF for a particular application, a check may be made to see if the built on application may be PegaRules. A check may be made to see the version. Previous applications built on the current application may be modified to the latest version of the current application.

For example, when an admin selects an application and clicks on the disable button, a DisableCGFApp activity may be called. An entry from the SynCGF-Data-Config-ApplicationCGFStatus table with the application name may be deleted. The DeactivateCGFApplication activity may be called. A dynamic system setting DSS_CGFModifiedTime may be updated to refresh a declare page in a node. The declare page may be expired using a @ExpireDeclarativePage function.

The DeactivateCGFApplication may open the selected application from the Database. If the application may be built on PegaRules, the SynCGF related rulesets may be removed from the ruleset stack and the process may end. If the current application may be built on another application then It may loop the application stack using the built on application until the built on application for the current application may become PegaRules. When the built on application becomes PegaRules then a check may be done to see whether a version exists for the current application. If it exists then the highest version for the application apart may be determined and may be added as the built on application for the previous application.

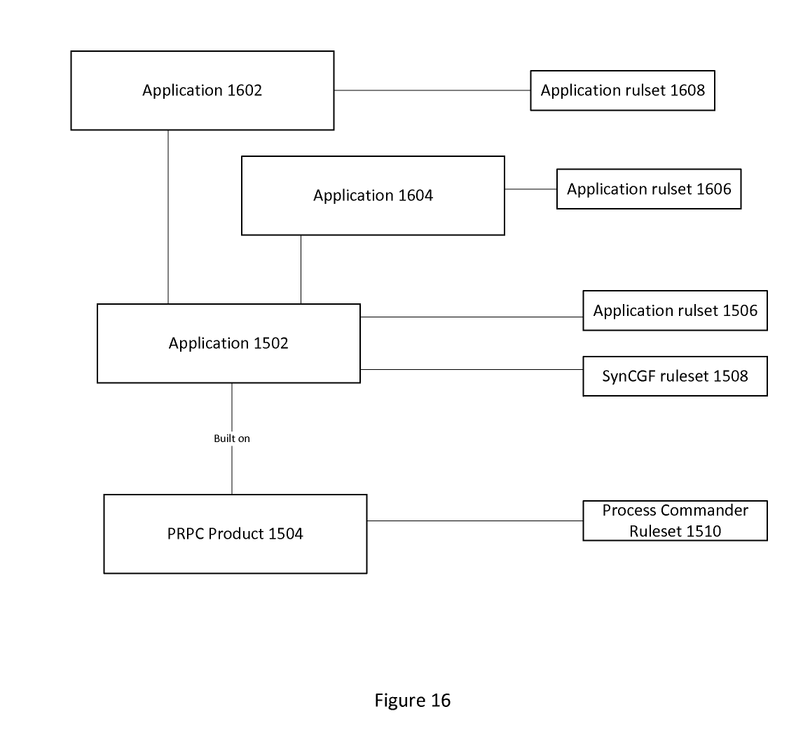

FIG. 16 depicts an example of a multiple applications with a governance framework (SGF) enabled. For example, application 1502 may have SGF enabled and may include application ruleset 1506 and SynCGF ruleset 1508. Application 1602 and Application 1604 may be associated with application 1502. Application 1602 may include application ruleset 1608. Application 1604 may include application ruleset 1606.

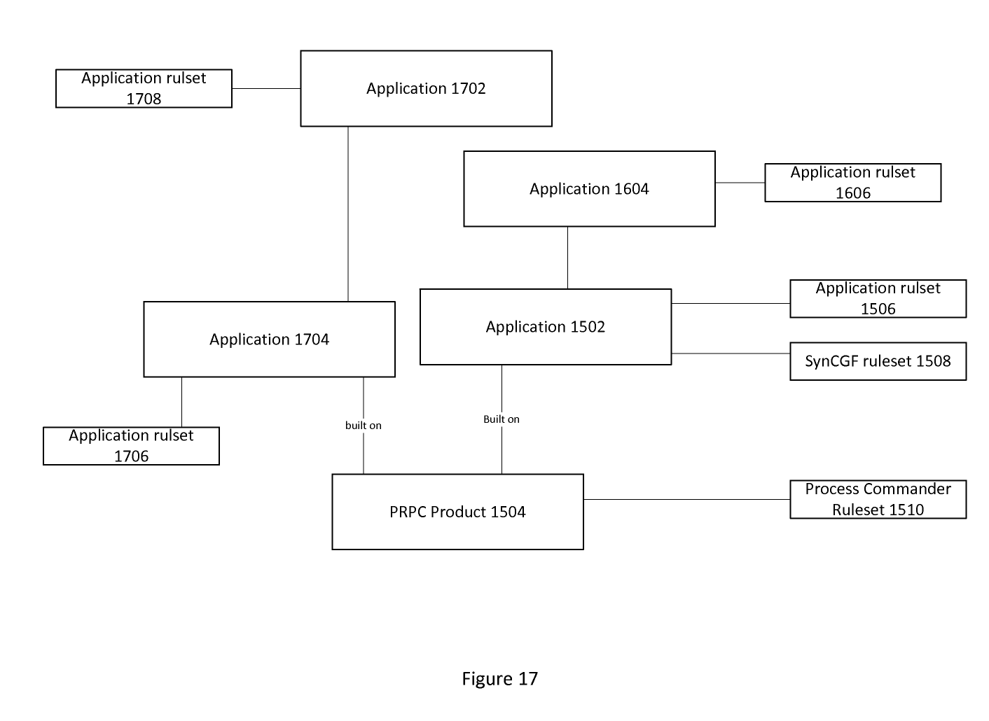

FIG. 17 depicts an example of multiple applications where an application may have a governance framework (SGF) enabled. Application 1502 may have SGF enabled. Application 1704 may not have SGF enabled. Application 1704 may be associated with application 1702. Application 1704 may include application ruleset 1706. Application 1702 may include application ruleset 1708.

What is claimed:

1. A computing device for providing a governance framework, the computing device comprising:
a processor configured to:
determine a rule to be integrated into an application being developed on a business process management (BPM) platform;
determine a ruleset based on the rule, the ruleset for preventing defects from being introduced into the application;
detecting an error within the rule by applying the ruleset to the rule; and
notifying a developer of the error within the rule.

2. The computing device of claim 1, wherein the processor is further configured to determine a team lead to approve the rule before it is integrated into the application.

3. The computing device of claim 2 wherein the processor is further configured to generate a work when the rule includes an error.

4. The computing device of claim 3, wherein the processor is further configured to:
assign the work item to the developer to ensure that the developer corrects the error; and
notify the team lead that the work item has been assigned.

5. The computing device of claim 4, wherein the processor is further configured to assign a work item to the team lead to ensure that the team lead approves the rule.

6. The computing device of claim 2, wherein the processor is further configured to receive an approval from the team lead and integrate the rule into the application.

7. The computing device of claim 1, wherein the rule is written in a programming language that is not native to the BPM platform.

8. The computing device of claim 1, wherein the rule is written in a procedural-rule based programming language and the BPM platform uses a declarative-rule based programming language.

9. The computing device of claim 1, wherein the rule comprises an objective and a circumstance.

10. A computing device for providing a governance framework, the computing device comprising:
a processor configured to:
retrieve a data instance to be integrated into an application being developed on a business process management (BPM) platform;
determine a validation for the application to be used for the data instance;
determine that the data instance fails the validation beyond a threshold; and
determine a save level, the save level indicating a number of times a developer has attempted to save the data instance.

11. The computing device of claim 10, wherein the save level is a first save, and the processor is further configured to:
display a warning to a developer associated with the data instance; and
assigning a work object to the developer.

12. The computing device of claim 10, wherein the save level is a second save, the work object is a first work object, and the processor is further configured to assign a second work object to a tech lead.

13. The computing device of claim 12, wherein the processor is further configured receive an approval from the tech lead.

14. The computing device of claim 12, wherein the processor is further configured to:
receive a rejection from the tech lead; and
notify the developer that of the rejection from the tech lead.

15. A computing device for providing a governance framework, the computing device comprising:
a processor configured to:
retrieve a special instance to be integrated into an application being developed on a business process management (BPM) platform;
determine a validation to be used for the special instance;
determine that the special instance does not pass the validation;
generate a work object that includes information about the special instance; and
assign the work object to a user to request that the user review the special instance before the special instance is introduced into the application.

16. The computing device of claim 15, wherein the processor is further configured to receive an approval from the user.

17. The computing device of claim 16, wherein the processor is further configured to:
resolve the work object;
update a transaction table; and
remove a warning message from a rule.

18. The computing device of claim 15, wherein the user is a first user and the processor is further configured to:
receive a message from the first user indicating that the special instance should be modified; and
assign the work object to a second user.

19. The computing device of claim 16, wherein the processor is further configured to introduce the special instance into the application.
